(19) United States
(12) Patent Application Publication
(10) Pub. No.: US 2022/0174441 A1
(43) Pub. Date: Jun. 2, 2022

(54) LOUDSPEAKER HAVING WIRE DAMPER WITH LOCALLY ADJUSTABLE ELASTICITY AND METHOD FOR MANUFACTURING THE SAME

(71) Applicant: Vincent Chen, Taipei City (TW)

(72) Inventor: Vincent Chen, Taipei City (TW)

(21) Appl. No.: 17/107,960

(22) Filed: Dec. 1, 2020

(51) Int. Cl. H04R 31/00; D06N 3/00; D03D 1/00; H04R 9/06; H04R 9/04

(52) U.S. Cl. CPC H04R 31/006; D06N 3/0006; H04R 9/025; H04R 9/06; H04R 9/043; D03D 1/00

(57) ABSTRACT

A method for manufacturing a loudspeaker having a wire damper with locally adjustable elasticity, including preparation, impregnating, drying, wire disposing, forming, cutting and assembling steps. Wherein, a wire damper including a main body and a wire is thermoformed on a base material. The main body includes a wave structure and a wire disposing area. The wave structure includes wave crest and trough, and inner and outer sidewalls. The wire disposing area forms a hollow portion in which the wire extends. The warp yarns at outside and inside of the wire disposing area form an elastic adjustment area. The hollow portion has smaller depths at the inner and outer sidewalls than at the wave crests and troughs. Thereby, the wire will not be damaged by thermal pressurization, and the hardness, elasticity and toughness of the combination of the wire disposing area and the wire are equal to that of other areas.

### BACKGROUND OF THE INVENTION

### 1. Field of the Invention

The present invention relates to a loudspeaker and a method for manufacturing the same, and more particularly, to a loudspeaker having a wire damper with locally adjustable elasticity and a method for manufacturing the same.

### 2. The Prior Arts

In the general moving coil loudspeaker, the principle that the reaction force of a fixed magnetic field causes another magnetic field to move in the opposite direction (i.e., opposite magnetisms attract each other, and like magnetisms repels each other) is used to produce sound. Further, the power alternating current generated by the power amplifier is transmitted to the voice coil through a wire to change the polarity of the magnetic field, such that the voice coil generates a reaction force against the fixed magnetic region generated by the magnetic circuit device. The forward pulse causes the diaphragm move outward relative to the magnet, while the backward pulse causes the diaphragm move inward. When the voice coil pushes the diaphragm to reciprocate, the diaphragm pushes air, and the air pressure changes to form sound waves. The damper is responsible for maintaining the correct position of the voice coil in the gap of the magnet core, ensuring that the voice coil reciprocates along the axis direction when being forced.

However, in the conventional loudspeaker, the wire is suspended in the air without any support, so that the wire alone bears the vibration force transmitted from the voice coil. Thereby, after the voice coil moves rapidly and frequently for a period of time, the wire is easy to fatigue and be broken.

In order to solve the above problems, in this industry, it has begun to develop the process of fixing the wires on the damper during the manufacturing procedure of the wire damper. First, a base material is impregnated in a liquid synthetic resin to allow the base material to absorb the synthetic resin; then, the base material absorbing the synthetic resin is dried and hardened; subsequently, the wire is fixedly adhered on the surface of the base material; next, the base material as well as the wire are subjected to thermal pressurization by the thermoforming device to form a wire damper; finally, the wire damper is cut from the base material by a cutting device. By using the main body of the wire damper to support the wire, the wire has an increased fatigue resistance and becomes not easy to be broken.

However, since the wire is fixedly adhered on the wire disposing area of the main body of the wire damper, when the wire damper is formed on the base material by thermoforming of a thermoforming device, the wire cannot stretch the warp yarns on both sides of the wire disposing area toward outer sides. As a result, the wire protrudes from the surface of the main body of the wire damper, causing the wire to be easily damaged by the thermal pressurization of the thermoforming device. The wire damper is unusable due to damage to the wire and must be scrapped, which is quite wasteful. It can be seen that the wire damper manufactured by conventional method has a low yield and a high manufacturing cost.

Furthermore, the wire is harder than the main body of the wire damper, and the elasticity and toughness of the wire are worse than that of the main body of the wire damper, so that under the condition that the wire cannot stretch the warp yarns on both sides of the wire disposing area toward outer sides, the combination of the wire disposing area and the wire is harder than the other areas of the main body of the wire damper, and the elasticity and toughness of the combination of the wire disposing area and the wire are worse than that of other areas of the main body of the wire damper. Therefore, the hardness, elasticity, and toughness of the wire damper are non-uniform, resulting in non-uniform elastic resilience and fatigue resistance of the wire damper, which causes the wire damper to be easy to deform, thereby affecting the output sound quality of the loudspeaker.

In addition, the thermoforming device requires larger pressurizing force to be able to form the wave crests and troughs of the wave structures on the base material, while the thermoforming device requires less pressurizing force to be able to form the inner sidewalls on the base material. It can be seen that the pressurizing force of the thermoforming device is non-uniform, so that the thermoforming device non-uniformly applies force to the wire, which causes the following two problems: first, the wire is easily deformed due to being non-uniformly forced; and second, the deformed wire will cause the overall structure of the wire damper to be unbalanced. The above two problems will affect the output sound quality of the loudspeaker.

### SUMMARY OF THE INVENTION

The main objective of the present invention is to provide a loudspeaker having a wire damper with locally adjustable elasticity and a method for manufacturing the same, which ensure that the wires will not be damaged by the thermal pressurization of the thermoforming device. As a result, the manufactured wire damper has a high yield and a low manufacturing cost.

Another objective of the present invention is to provide a loudspeaker having a wire damper with locally adjustable elasticity and a method for manufacturing the same, wherein the wire damper has uniform hardness, elasticity and toughness, thereby having uniform elastic resilience and fatigue resistance, and being not easy to be deformed and brittle, which improves the output sound quality of the loudspeaker.

Yet another objective of the present invention is to provide a loudspeaker having a wire damper with locally adjustable elasticity and a method for manufacturing the same, wherein the thermoforming device can uniformly apply force to the wires, such that the wires can maintain their original shape and will not be deformed, thereby improving the output sound quality of the loudspeaker.

Still another objective of the present invention is to provide a loudspeaker having a wire damper with locally adjustable elasticity and a method for manufacturing the same, which ensure that the wire damper has a more balanced overall structure, thereby being not easy to be deformed and brittle, which improves the output sound quality of the loudspeaker.

In order to achieve the above objectives, the present invention provides a method for manufacturing a loudspeaker having a wire damper with locally adjustable elasticity, including: a preparation step, an impregnating step, a drying step, a wire disposing step, a forming step, a cutting step, and an assembling step.

In the preparation step, a base material, which is a single-layer fabric structure and is formed by interweaving a plurality of warp yarns and a plurality of weft yarns, is prepared.

In the impregnating step, the base material is impregnated in a resin solution.

In the drying step, the base material is dried to form a solid resin layer on the base material.

In the wire disposing step, at least one wire is disposed on the base material.

In the forming step, a wire damper is formed on the base material by thermoforming, in which the wire damper includes a main body and the at least one wire, the main body is a single-layer piece structure formed by interweaving the warp yarns and the weft yarns, the solid resin layer is formed on a surface of the main body, the main body includes a plurality of wave structures, a center hole and at least one wire disposing area, the wave structures are sequentially arranged from an outer edge of the main body to the center hole, each wave structure includes a wave crest, a wave trough, an inner sidewall and an outer sidewall, and the at least one wire disposing area extends radially from the outer edge of the main body through the wave structures to the center hole; wherein the at least one wire disposing area is recessed inwardly to form at least one hollow portion, the at least one wire extends in the at least one hollow portion, and both ends of the at least one wire respectively penetrate an inner edge and the outer edge of the main body; wherein a first elastic adjustment area is formed between the warp yarn closest to outside of a first side of the at least one wire disposing area and the warp yarn at inside of the at least one wire disposing area, a second elastic adjustment area is formed between the warp yarn closest to outside of a second side of the at least one wire disposing area and the warp yarn at the inside of the at least one wire disposing area, widths of the first elastic adjustment area and the second elastic adjustment area are equal to each other, and distances between the remaining warp yarns are less than the width of each of the first elastic adjustment area and the second elastic adjustment area; and wherein each of depths of the at least one hollow portion at the inner sidewalls and the outer sidewalls is less than a depth of the at least one hollow portion at the wave crests, and each of the depths of the at least one hollow portion at the inner sidewalls and the outer sidewalls is less than a depth of the at least one hollow portion at the wave troughs.

In the cutting step, the wire damper is cut from the base material.

In the assembling step, a voice coil is movably disposed in a loudspeaker body, the center hole of the wire damper is sleeved at the voice coil, and the at least one wire of the wire damper is connected to the voice coil, so as to assemble a loudspeaker.

In order to achieve the above objectives, the present invention provides a method for manufacturing a loudspeaker having a wire damper with locally adjustable elasticity, including: a preparation step, an impregnating step, a drying step, a wire disposing step, a forming step, a cutting step, and an assembling step.

In the preparation step, a base material, which is a double-layer fabric structure and includes a first fabric and a second fabric, is prepared. The first fabric is formed by interweaving a plurality of first warp yarns and a plurality of first weft yarns, the second fabric is formed by interweaving a plurality of second warp yarns and a plurality of second weft yarns.

In the impregnating step, the first fabric and the second fabric are impregnated in a resin solution, respectively.

In the drying step, the first fabric and the second fabric are dried to form a first solid resin layer on the first fabric, and to form a second solid resin layer on the second fabric.

In the wire disposing step, at least one wire is first disposed on the first fabric, and the second fabric is then disposed on the first fabric, so as to form the base material.

In the forming step, a wire damper is formed on the base material by thermoforming, in which the wire damper includes a main body and the at least one wire, the main body is a double-layer piece structure and includes a first piece and a second piece, the first piece is formed by interweaving a plurality of first warp yarns and a plurality of first weft yarns, a first solid resin layer is formed on a surface of the first piece, the first piece includes a plurality of first wave structures, a first center hole and at least one first wire disposing area, the first wave structures are sequentially arranged from an outer edge of the first piece to the first center hole, each first wave structure includes a first wave crest, a first wave trough, a first inner sidewall and a first outer sidewall, the at least one first wire disposing area extends radially from the outer edge of the first piece through the first wave structures to the first center hole, the second piece is formed by interweaving a plurality of second warp yarns and a plurality of second weft yarns, a second solid resin layer is formed on a surface of the second piece, the second piece includes a plurality of second wave structures, a second center hole and at least one second wire disposing area, the second wave structures are sequentially arranged from an outer edge of the second piece to the second center hole, each second wave structure includes a second wave crest, a second wave trough, a second inner sidewall and a second outer sidewall, the at least one second wire disposing area extends radially from the outer edge of the second piece through the second wave structures to the second center hole; wherein the first piece is combined with the second piece, and the at least one first wire disposing area corresponds to the at least one second wire disposing area; wherein the at least one first wire disposing area is recessed inwardly to form at least one first trench, the at least one second wire disposing area is recessed inwardly to form at least one second trench, the at least one first trench and the at least one second trench together form at least one hollow portion, the at least one wire extends in the at least one hollow portion, and both ends of the at least one wire respectively penetrate inner edges and the outer edges of the first piece and the second piece; wherein a first lower elastic adjustment area is formed between the first warp yarn closest to outside of a first side of the at least one first wire disposing area and the first warp yarn at inside of the at least one first wire disposing area, a second lower elastic adjustment area is formed between the first warp yarn closest to outside of a second side of the at least one first wire disposing area and the first warp yarn at the inside of the at least one first wire disposing area, widths of the first lower elastic adjustment area and the second lower elastic adjustment area are equal to each other, and distances between the remaining first warp yarns are less than the width of each of the first lower elastic adjustment area and the second lower elastic adjustment area; wherein a first upper elastic adjustment area is formed between the second warp yarn closest to outside of a first side of the at least one second wire disposing area and the second warp yarn at inside of the at least one second wire disposing area, a second upper elastic adjustment area is formed between the second warp yarn closest to outside of a second side of the at least one second wire disposing area and the second warp yarn at the inside of the at least one second wire disposing area, widths of the first upper elastic adjustment area and the second upper elastic adjustment area are equal to each other, and distances between the remaining second warp yarns are less than the width of each of the first upper elastic adjustment area and the second upper elastic adjustment area; and wherein a depth of the at least one first trench at the first wave crests is less than a depth of the at least one second trench at the second wave crests, a depth of the at least one first trench at the first wave troughs is greater than a depth of the at least one second trench at the second wave troughs, a depth of the at least one first trench at the first inner sidewalls is equal to a depth of the at least one second trench at the second inner sidewalls, a depth of the at least one first trench at the first outer sidewalls is equal to a depth of the at least one second trench at the second outer sidewall s.

In the cutting step, the wire damper is cut from the base material.

In the assembling step, a voice coil is movably disposed in a loudspeaker body, the first center hole and the second center hole of the wire damper are sleeved at the voice coil, and the at least one wire of the wire damper is connected to the voice coil, so as to assemble a loudspeaker.

In order to achieve the above objectives, the present invention provides a loudspeaker having a wire damper with locally adjustable elasticity, including a loudspeaker body, a voice coil and a wire damper. The voice coil is movably disposed in the loudspeaker body. The wire damper includes a main body and the at least one wire. The main body is a single-layer piece structure formed by interweaving a plurality of warp yarns and a plurality of weft yarns, a solid resin layer is formed on a surface of the main body, the main body includes a plurality of wave structures, a center hole and at least one wire disposing area, the wave structures are sequentially arranged from an outer edge of the main body to the center hole, each wave structure includes a wave crest, a wave trough, an inner sidewall and an outer sidewall, the center hole is sleeved at the voice coil, the at least one wire disposing area extends radially from the outer edge of the main body through the wave structures to the center hole; wherein the at least one wire disposing area is recessed inwardly to form at least one hollow portion; wherein a first elastic adjustment area is formed between the warp yarn closest to outside of a first side of the at least one wire disposing area and the warp yarn at inside of the at least one wire disposing area, a second elastic adjustment area is formed between the warp yarn closest to outside of a second side of the at least one wire disposing area and the warp yarn at the inside of the at least one wire disposing area, widths of the first elastic adjustment area and the second elastic adjustment area are equal to each other, and distances between the remaining warp yarns are less than the width of each of the first elastic adjustment area and the second elastic adjustment area; and wherein each of depths of the at least one hollow portion at the inner sidewalls and the outer sidewalls is less than a depth of the at least one hollow portion at the wave crests, and each of the depths of the at least one hollow portion at the inner sidewalls and the outer sidewalls is less than a depth of the at least one hollow portion at the wave troughs. The at least one wire extends in the at least one hollow portion, both ends of the at least one wire respectively penetrate an inner edge and the outer edge of the main body, and one end of the at least one wire is connected to the voice coil.

In order to achieve the above objectives, the present invention provides a loudspeaker having a wire damper with locally adjustable elasticity, including a loudspeaker body, a voice coil and a wire damper. The voice coil is movably disposed in the loudspeaker body. The wire damper includes a main body and the at least one wire. The main body is a double-layer piece structure and includes a first piece and a second piece, the first piece is formed by interweaving a plurality of first warp yarns and a plurality of first weft yarns, a first solid resin layer is formed on a surface of the first piece, the first piece includes a plurality of first wave structures, a first center hole and at least one first wire disposing area, the first wave structures are sequentially arranged from an outer edge of the first piece to the first center hole, each first wave structure includes a first wave crest, a first wave trough, a first inner sidewall and a first outer sidewall, the at least one first wire disposing area extends radially from the outer edge of the first piece through the first wave structures to the first center hole, the second piece is formed by interweaving a plurality of second warp yarns and a plurality of second weft yarns, a second solid resin layer is formed on a surface of the second piece, the second piece includes a plurality of second wave structures, a second center hole and at least one second wire disposing area, the second wave structures are sequentially arranged from an outer edge of the second piece to the second center hole, each second wave structure includes a second wave crest, a second wave trough, a second inner sidewall and a second outer sidewall, the at least one second wire disposing area extends radially from the outer edge of the second piece through the second wave structures to the second center hole; wherein the first piece is combined with the second piece, and the at least one first wire disposing area corresponds to the at least one second wire disposing area, the first center hole and the second center hole are sleeved at the voice coil; wherein the at least one first wire disposing area is recessed inwardly to form at least one first trench, the at least one second wire disposing area is recessed inwardly to form at least one second trench, the at least one first trench and the at least one second trench together form at least one hollow portion; wherein a first lower elastic adjustment area is formed between the first warp yarn closest to outside of a first side of the at least one first wire disposing area and the first warp yarn at inside of the at least one first wire disposing area, a second lower elastic adjustment area is formed between the first warp yarn closest to outside of a second side of the at least one first wire disposing area and the first warp yarn at the inside of the at least one first wire disposing area, widths of the first lower elastic adjustment area and the second lower elastic adjustment area are equal to each other, and distances between the remaining first warp yarns are less than the width of each of the first lower elastic adjustment area and the second lower elastic adjustment area; wherein a first upper elastic adjustment area is formed between the second warp yarn closest to outside of a first side of the at least one second wire disposing area and the second warp yarn at inside of the at least one second wire disposing area, a second upper elastic adjustment area is formed between the second warp yarn closest to outside of a second side of the at least one second wire disposing area and the second warp yarn at the inside of the at least one second wire disposing area, widths of the first upper elastic adjustment area and the second upper elastic adjustment area are equal to each other, and distances between the remaining second warp yarns are less than the width of each of the first upper elastic adjustment area and the second upper elastic adjustment area; and wherein a depth of the at least one first trench at the first wave crests is less than a depth of the at least one second trench at the second wave crests, a depth of the at least one first trench at the first wave troughs is greater than a depth of the at least one second trench at the second wave troughs, a depth of the at least one first trench at the first inner sidewalls is equal to a depth of the at least one second trench at the second inner sidewalls, a depth of the at least one first trench at the first outer sidewalls is equal to a depth of the at least one second trench at the second outer sidewalls. the at least one wire extends in the at least one hollow portion, and both ends of the at least one wire respectively penetrate inner edges and the outer edges of the first piece and the second piece, and one end of the at least one wire is connected to the voice coil.

The present invention has the advantageous in that the wire disposing areas can be pressurized by the wires, thereby recessing inwardly to form the hollow portions. It ensures that the wires will not be damaged by the thermal pressurization of the thermoforming device. As a result, the manufactured wire damper has a high yield and a low manufacturing cost.

Furthermore, the hardness, elasticity and toughness of the wire disposing areas can be adjusted by the elastic adjustment areas. Therefore, the wire disposing areas become softer, and their elasticity and toughness are increased. Thereby, the hardness, elasticity, and toughness of the combination of the wire disposing areas and the wires are equivalent to that of other areas of the main body. Therefore, the wire damper has uniform hardness, elasticity and toughness, thereby having uniform elastic resilience and fatigue resistance, and being not easy to be deformed and brittle, which improves the output sound quality of the loudspeaker.

Further, since the hollow portions with non-uniform depth allow the wires to extend therein in an non-uniform arrangement manner, the thermoforming device can uniformly apply force to the wires, such that the wires can maintain their original shape and will not be deformed, thereby improving the output sound quality of the loudspeaker.

In addition, the present invention can ensure that the wire damper has a more balanced overall structure, thereby being not easy to be deformed and brittle, which improves the output sound quality of the loudspeaker.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block flow diagram of the manufacturing method of the present invention;

FIG. 2 is a schematic flow diagram of the first embodiment of the manufacturing method of the present invention;

FIG. 3 is a perspective view of the first embodiment of the loudspeaker of the present invention;

FIG. 4 is an exploded view of the first embodiment of the loudspeaker of the present invention;

FIG. 5 is a cross-sectional view of the first embodiment of the loudspeaker of the present invention;

FIG. 6 is a perspective view of the wire damper of the first embodiment of the present invention;

FIG. 7 is an exploded view of the wire damper of the first embodiment of the present invention;

FIG. 8 is a cross-sectional view along line A-A of FIG. 6;

FIG. 9 is a cross-sectional view along line B-B of FIG. 6;

FIG. 10 is a cross-sectional view along line C1-C1 and line C2-C2 of FIG. 6;

FIGS. 11A and 11B are schematic flow diagrams of the second embodiment of the manufacturing method of the present invention;

FIG. 12 is a perspective view of a wire damper of the second embodiment of the present invention;

FIG. 13 is an exploded view of the wire damper of the second embodiment of the present invention;

FIG. 14 is a cross-sectional view along line D-D of FIG. 12;

FIG. 15 is a cross-sectional view along line E-E of FIG. 12; and

FIG. 16 is a cross-sectional view along line F1-F1 and line F2-F2 of FIG. 12.

### DETAILED DESCRIPTION OF THE PREFERRED EMBODIMENT

Embodiments of the present invention will be described in more detail below with reference to the drawings and the reference numerals, such that those skilled in the art can implement it after studying this specification.

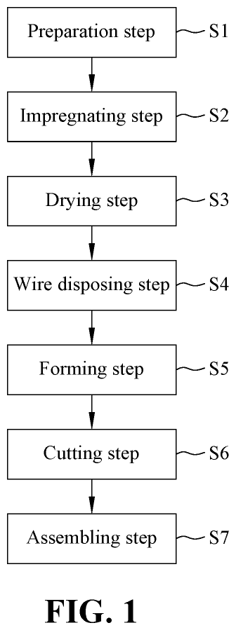

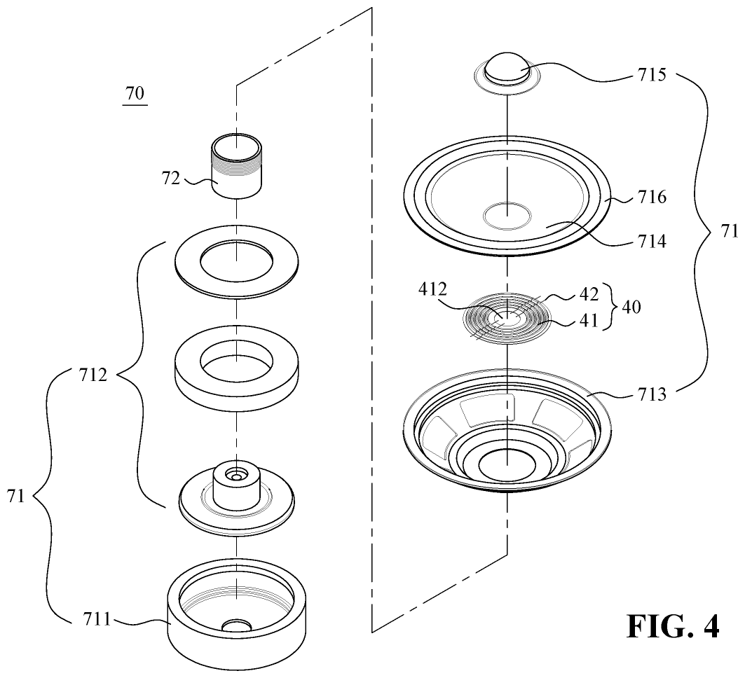

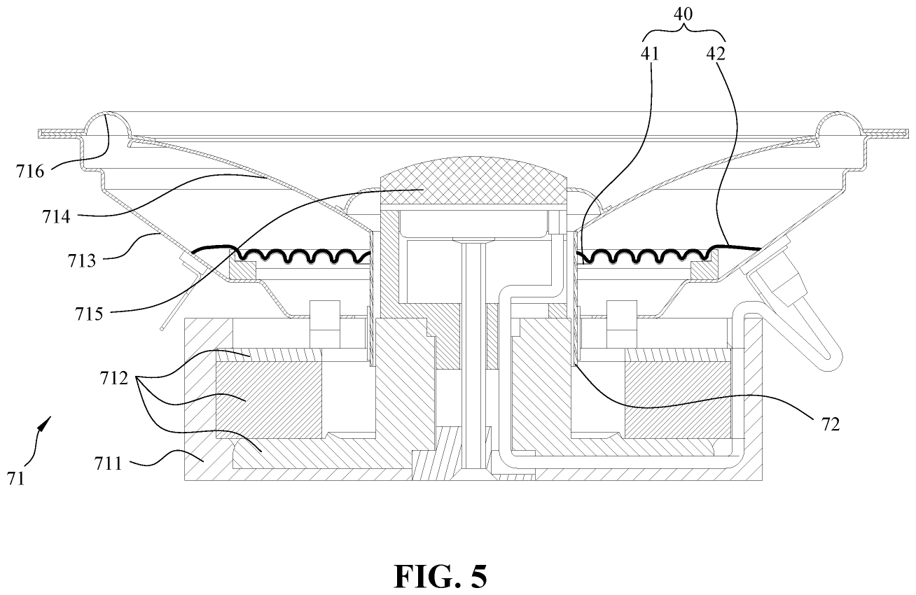

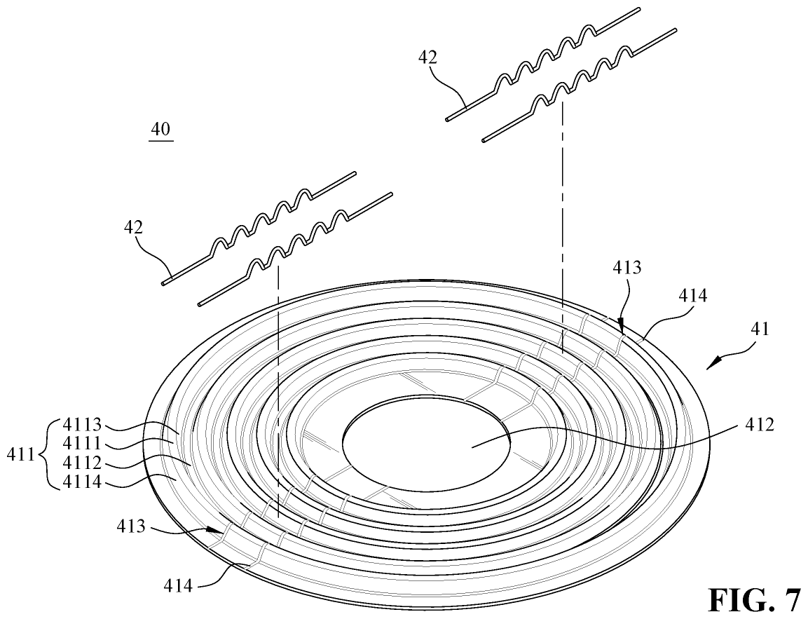

Referring to FIGS. 1 to 10, the present invention provides a method for manufacturing a loudspeaker having a wire damper with locally adjustable elasticity, including: a preparation step S1, an impregnating step S2, a drying step S3, a wire disposing step S4, a forming step S5, a cutting step S6, and an assembling step S7.

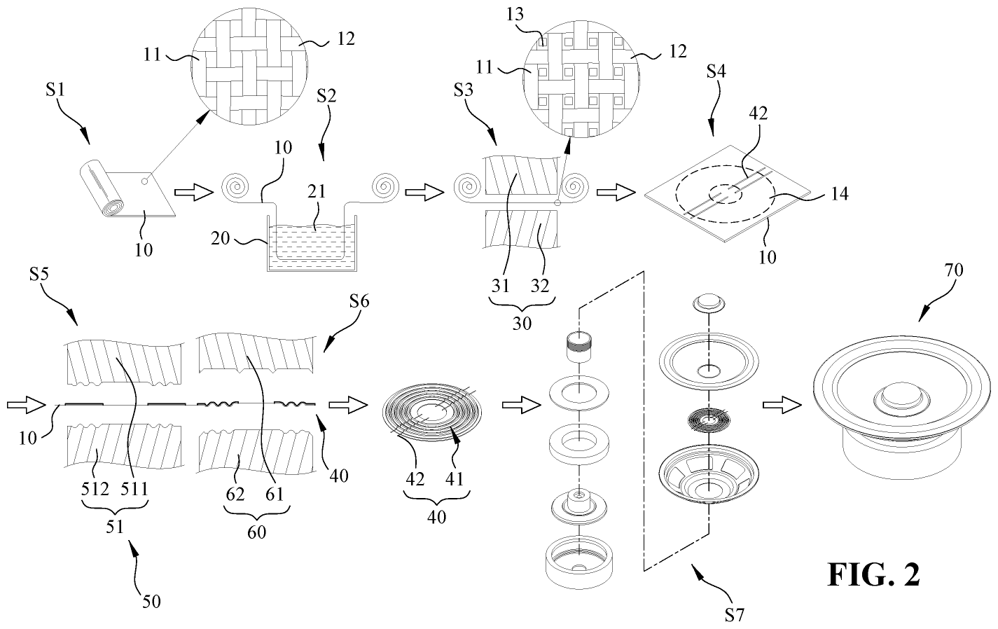

In the preparation step S1, as shown in FIG. 2, a base material 10, which is a single-layer fabric structure and is formed by interweaving a plurality of warp yarns 11 and a plurality of weft yarns 12, is prepared.

In the impregnating step S2, as shown in FIG. 2, the base material 10 is impregnated in a resin solution 21 in a resin tank 20, such that the warp yarns 11 and the weft yarns 12 adsorb the resin and are adhered with the resin.

In the drying step S3, as shown in FIG. 2, a drying device 30 includes an upper baking plate 31 and a lower baking plate 32. By utilizing the temperature of the upper baking plate 31 and the lower baking plate 32, the moisture and volatile substances in the resin on the base material 10 are removed such that the base material 10 is dried. Meanwhile, the resin penetrates into the base material 10 and is adhered onto the warp yarns 11 and the weft yarns 12, so as to form a solid resin layer 13.

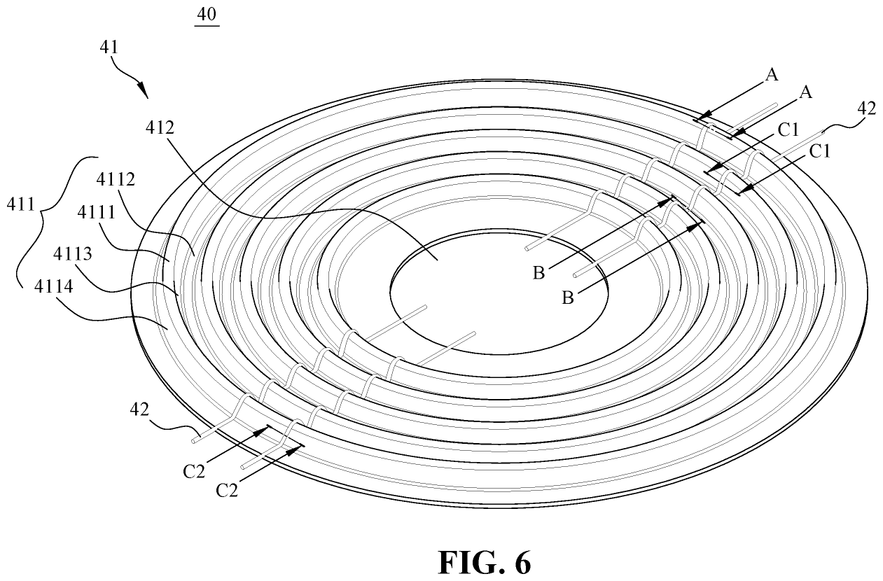

In the wire disposing step S4, as shown in FIG. 2, at least one wire 42 is disposed on the base material 10. In the first embodiment, each of damper forming areas 14 on the base material 10 is provided with four wires 42. However, the number of the wires 42, provided in each damper forming area 14 on the base material 10, are not limited to this. Preferably, as shown in FIGS. 6 to 9, the cross section of each wire 42 is circular. In other embodiments, the cross section of each wire 42 may also be a flat section.

In the forming step S5, as shown in FIG. 2, a thermoforming device 50 comprises a forming mold 51 and a heating device (not shown), and the forming mold 51 includes an upper mold 511 and a lower mold 512. When the upper mold 511 and the lower mold 512 fit together and pressurize the base material 10, the heating device is applied with electricity to increase the temperature of the upper mold 511 and the lower mold 512, thereby softening the resin on the base material 10. In addition to destroying the resin structure, the resin also fills up in the gaps, and thus respective parts of the resin are connected with each other to form the final morphology of the solid resin layer 13. Therefore, the resin cover between the warp yarns 11 and the weft yarns 12, thereby forming a wire damper 40 on each damper forming area 14 of the base material 10 by thermoforming.

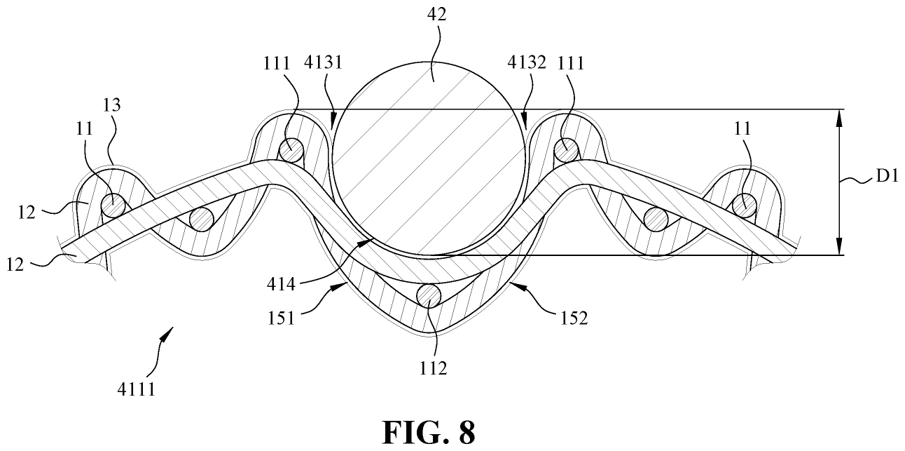

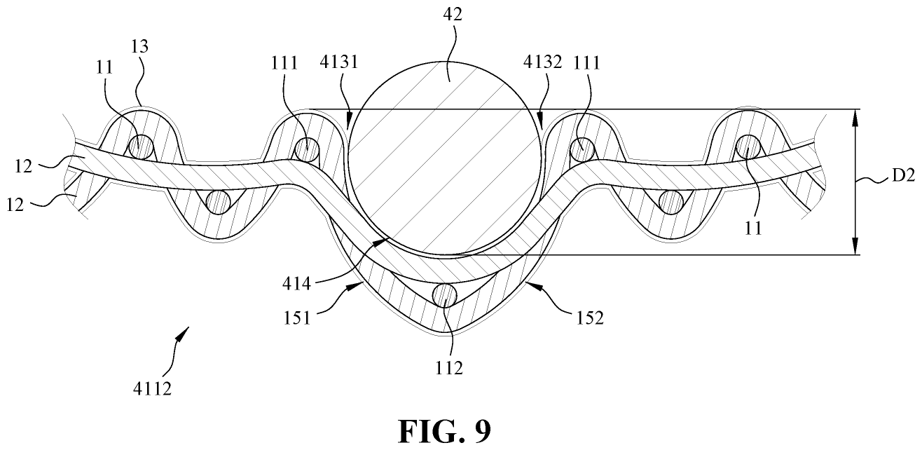

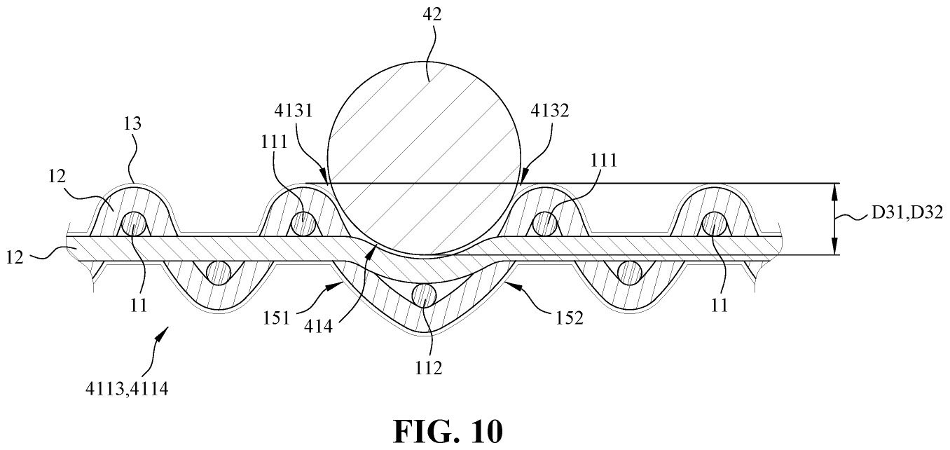

As shown in FIGS. 6 to 10, the wire damper 40 includes a main body 41 and the at least one wire 42. The main body 41 is a single-layer piece structure, which is formed by interweaving the warp yarns 11 and the weft yarns 12, and the solid resin layer 13 is formed on the surface of the main body 41. The main body 41 includes a plurality of wave structures 411, a center hole 412, and at least one wire disposing area 413. The wave structures 411 are sequentially arranged from the outer edge of the main body 41 to the center hole 412. Each wave structure 411 includes a wave crest 4111, a wave trough 4112, an inner sidewall 4113, and an outer sidewall 4114. The at least one wire disposing area 413 extends radially from the outer edge of the main body 41 through the wave structures 411 to the center hole 412. The at least one wire disposing area 413 is recessed inwardly to form at least one hollow portion 414. The at least one wire 42 extends in the at least one hollow portion 414, and both ends of the at least one wire 42 respectively penetrate the inner and outer edges of the main body 41. As shown in FIGS. 8 to 10, a first elastic adjustment area 151 is formed between a warp yarn 111 closest to outside of a first side 4131 of the at least one wire disposing area 413 and a warp yarn 112 at inside of the at least one wire disposing area 413. A second elastic adjustment area 152 is formed between a warp yarn 111 closest to outside of a second side 4132 of the at least one wire disposing area 413 and the warp yarn 112 at inside of the at least one wire disposing area 413. The widths of the first elastic adjustment area 151 and the second elastic adjustment area 152 are equal to each other, and the distances between the remaining warp yarns 11 are less than the width of each of the first elastic adjustment area 151 and the second elastic adjustment area 152. As shown in FIGS. 8 to 10, the depth D31 of the at least one hollow portion 414 at the inner sidewalls 4113 is less than the depth D1 of the at least one hollow portion 414 at the wave crests 4111. The depth D32 of the at least one hollow portion 414 at the outer sidewalls 4114 is less than the depth D1 of the at least one hollow portion 414 at the wave crests 4111. The depth D31 of the at least one hollow portion 414 at the inner sidewalls 4113 is less than the depth D2 of the at least one hollow portion 414 at the wave troughs 4112. The depth D32 of the at least one hollow portion 414 at the outer sidewalls 4114 is less than the depth D2 of the at least one hollow portion 414 at the wave troughs 4112. Preferably, as shown in FIGS. 8 and 9, the depth D1 of the at least one hollow portion 414 at the wave crests 4111 is equal to the depth D2 of the at least one hollow portion 414 at the wave troughs 4112; and as shown in FIG. 10, the depth D31 of the at least one hollow portion 414 at the inner sidewalls 4113 is equal to the depth D32 of the at least one hollow portion 414 at the outer sidewalls 4114. In the first embodiment, the wire damper 40 includes four wires 42, and the main body 41 includes four wire disposing areas 413. The wires 42 are respectively disposed at the wire disposing areas 413. The wire disposing areas 413 are recessed inwardly to form four hollow portions 414. The wires 42 extend in the hollow portions 414 respectively.

In the cutting step S6, as shown in FIG. 2, a cutting device 60 includes an upper cutting tool 61 and a lower cutting tool 62. The wire damper 40 is cut from the base material 10 by the upper cutting tool 61 and the lower cutting tool 62, such that the wire damper 40 is separated from the base material 10.

In the assembling step S7, as shown in FIGS. 2 to 5, a loudspeaker body 71 includes a base 711, a magnetic circuit device 712, an outer frame 713, a diaphragm 714, a dust cover 715, and a surround 716. The magnetic circuit device 712 is disposed on the base 711. A voice coil 72 is movably disposed in the magnetic circuit device 712. The outer frame 713 is disposed at upper side of the magnetic circuit device 712 and supports the outer edge of the main body 41 of the wire damper 40. The diaphragm 714 is sleeved at the voice coil 72. The dust cover 715 is disposed on a center hole of the diaphragm 714. The surround 716 is disposed between the top edge of the diaphragm 714 and the outer frame 713. The center hole 412 of the wire damper 40 is sleeved at the voice coil 72, and the wires 42 of the wire damper 40 are connected to the voice coil 72. Thereby, the loudspeaker body 71, the voice coil 72 and the wire damper 40 are assembled together to form a loudspeaker 70.

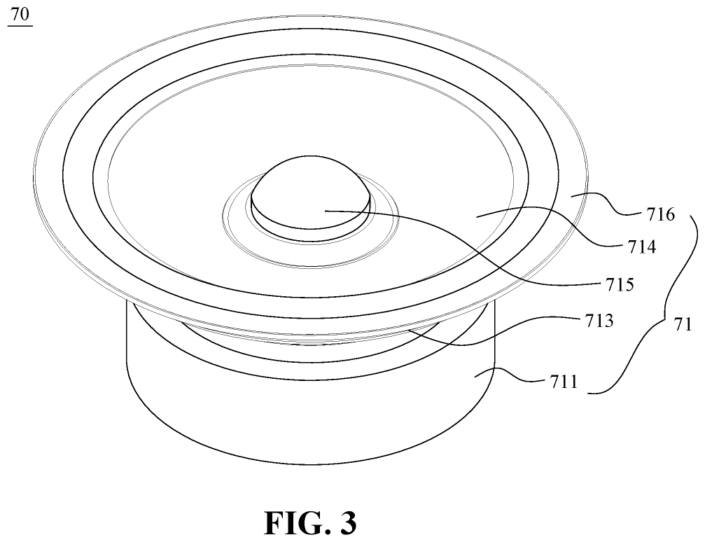

As shown in FIGS. 3 to 10, the present invention provides a loudspeaker 70 having a wire damper with locally adjustable elasticity, including a loudspeaker body 71, a voice coil 72, and a wire damper 40. The structure of the loudspeaker body 71, the voice coil 72, and the wire damper 40 and their connection relationship are as described above.

According to this, since the wires 42 are not fixedly adhered onto the surface of the yarns of the base material 10 when being disposed on the base material 10, when the wire damper 40 is formed on the base material 10 by thermoforming of the thermoforming device 50, the wire disposing areas 413 can be pressurized by the wires 42, thereby recessing inwardly to form the hollow portions 414. It ensures that the wires 42 will not be damaged by the thermal pressurization of the thermoforming device 50. As a result, the manufactured wire damper 40 has a high yield and a low manufacturing cost.

Furthermore, by the first elastic adjustment areas 151 and the second elastic adjustment areas 152, the hardness, elasticity and toughness of the wire disposing areas 413 can be adjusted. Therefore, the wire disposing areas 413 become softer, and their elasticity and toughness are increased. Thereby, the hardness, elasticity, and toughness of the combination of the wire disposing areas 413 and the wires 42 are equivalent to that of other areas of the main body 41. Therefore, the wire damper 40 has uniform hardness, elasticity and toughness, thereby having uniform elastic resilience and fatigue resistance, and being not easy to be deformed and brittle, which improves the output sound quality of the loudspeaker.

In addition, the thermoforming device 50 must uniformly apply force to each wire 42 to ensure that each wire 42 will not be deformed due to being non-uniformly forced. However, the thermoforming device 50 requires larger pressurizing force to be able to form the wave crests 4111 and the wave troughs 4112 by thermoforming; and the thermoforming device 50 requires less pressurizing force to be able to form the inner sidewalls 4113 and the outer sidewalls 4114 by thermoforming. Therefore, the depth D31 of the hollow portions 414 at the inner sidewalls 4113 is less than the depth D1 of the hollow portions 414 at the wave crests 4111. The depth D32 of the hollow portions 414 at the outer sidewalls 4114 is less than the depth D1 of the hollow portions 414 at the wave crests 4111. The depth D31 of the hollow portions 414 at the inner sidewalls 4113 is less than the depth D2 of the hollow portions 414 at the wave troughs 4112. The depth D32 of the hollow portions 414 at the outer sidewalls 4114 is less than the depth D2 of the hollow portions 414 at the wave troughs 4112. In other words, the depths of the hollow portions 414 are non-uniform. Since the hollow portions 414 with non-uniform depth allow the wires 42 to extend therein in an non-uniform arrangement manner, the thermoforming device 50 can uniformly apply force to each wire 42, such that the wires 42 can maintain their original shape and will not be deformed, thereby improving the output sound quality of the loudspeaker. Under the condition that the wires 42 maintain their original shapes, relative large parts of volumes of the wires 42 are positioned in the hollow portions 414 at the wave crests 4111 and the wave troughs 4112, while relative small parts of volumes of the wires 42 are positioned in the hollow portions 414 at the inner sidewalls 4113 and the outer sidewalls 4114. Also, relative small parts of volume of the wires 42 are exposed on the surface of the main body 41 at the wave crests 4111 and the wave troughs 4112, while relative large parts of volumes of the wires 42 are exposed on the surface of the main body 41 at the inner sidewalls 4113 and the outer sidewalls 4114.

In addition, the depth D1 of the hollow portions 414 at the wave crests 4111 is equal to the depth D2 of the hollow portions 414 at the wave troughs 4112, such that the volumes of the wires 42 positioned in the hollow portions 414 at the wave crests 4111 and the wave troughs 4112 are equal to each other, and the volumes of the wires 42 exposed on the surface of the main body 41 at the wave crests 4111 and the wave troughs 4112 are equal to each other. Furthermore, since the depth D31 of the hollow portions 414 at the inner sidewalls 4113 is equal to the depth D32 of the hollow portions 414 at the outer sidewalls 4114, the volumes of the wires 42 positioned in the hollow portions 414 at the inner sidewalls 4113 and the outer sidewalls 4114 are equal to each other, and the volumes of the wires 42 exposed on the surface of the main body 41 at the inner sidewalls 4113 and the outer sidewalls 4114 are equal to each other. Therefore, the wire damper 40 has a more balanced overall structure with uniform hardness, elasticity and toughness, thereby having uniform elastic resilience and fatigue resistance, and being not easy to be deformed and brittle, which improves the output sound quality of the loudspeaker.

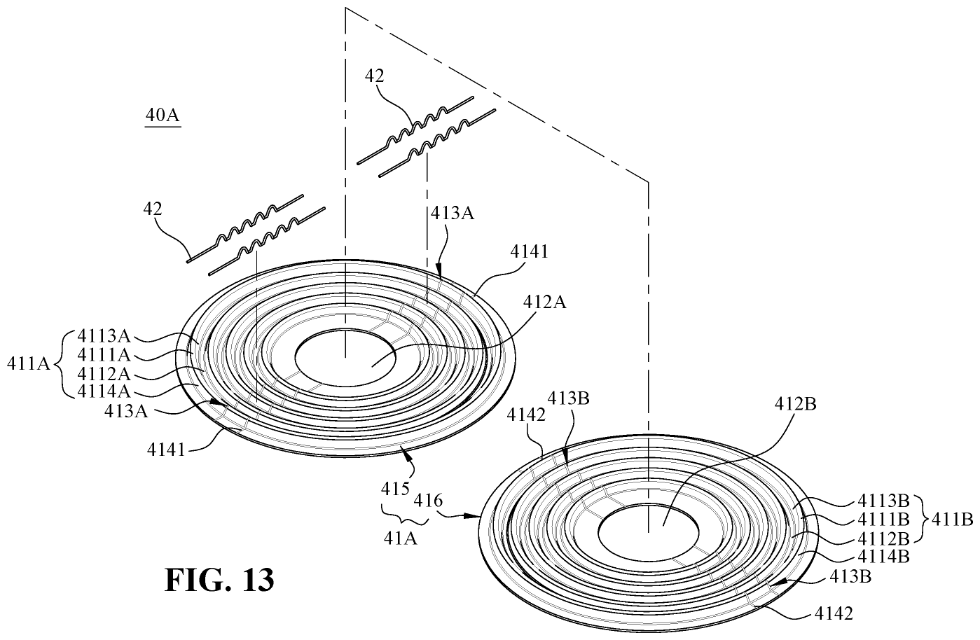

Referring to FIG. 1 and FIGS. 11A to 16, the present invention provides a method for manufacturing a loudspeaker having a wire damper with locally adjustable elasticity, wherein the manufacturing method of the second embodiment is different from that of the first embodiment as following.

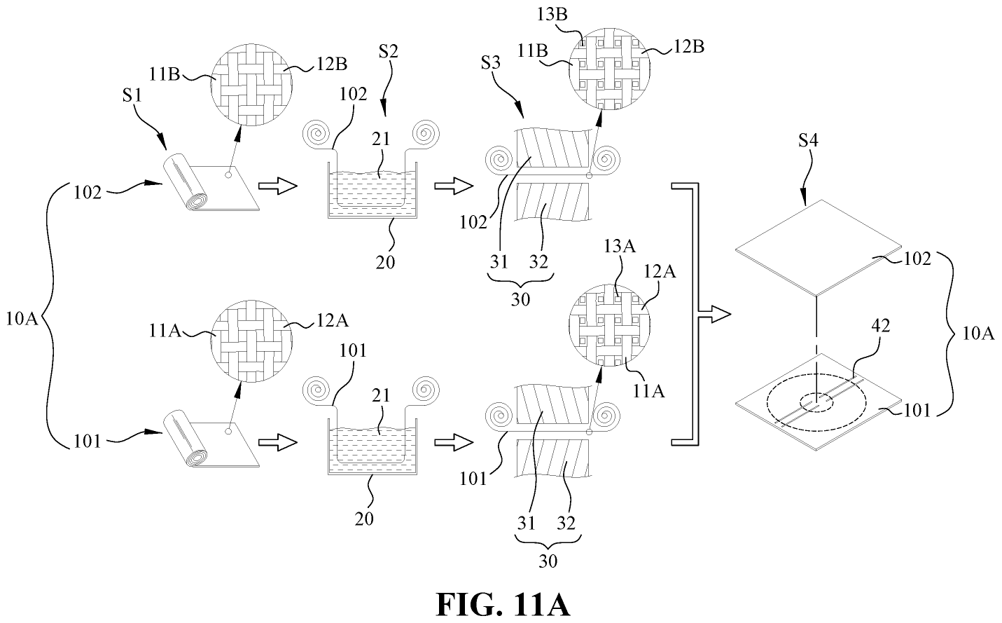

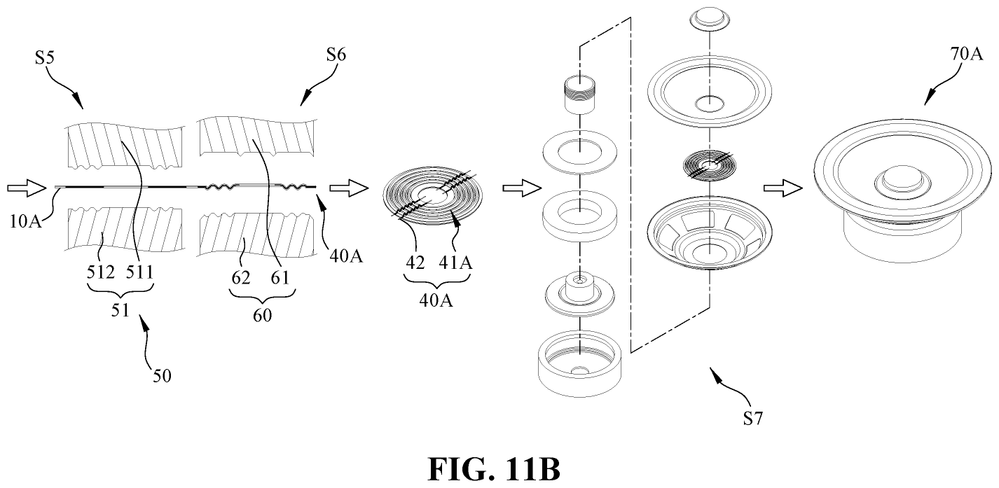

In a preparation step S1, as shown in FIG. 11A, a base material 10A is a double-layer fabric structure and includes a first fabric 101 and a second fabric 102. The first fabric 101 is formed by interweaving a plurality of first warp yarns 11A and a plurality of first weft yarns 12A. The second fabric 102 is formed by interweaving a plurality of second warp yarns 11B and a plurality of second weft yarns 12B.

In an impregnating step S2, as shown in FIG. 11A, the first fabric 101 and the second fabric 102 are impregnated in a resin solution 21, respectively.

In a drying step S3, as shown in FIG. 11A, the first fabric 101 and the second fabric 102 are dried, so as to form a first solid resin layer 13A on the first fabric 101, and to form a second solid resin layer 13B on the second fabric 102.

In a wire disposing step S4, as shown in FIG. 11A, at least one wire 42 is first disposed on the first fabric 101, and the second fabric 102 is then disposed on the first fabric 101, so as to form the base material 10A.

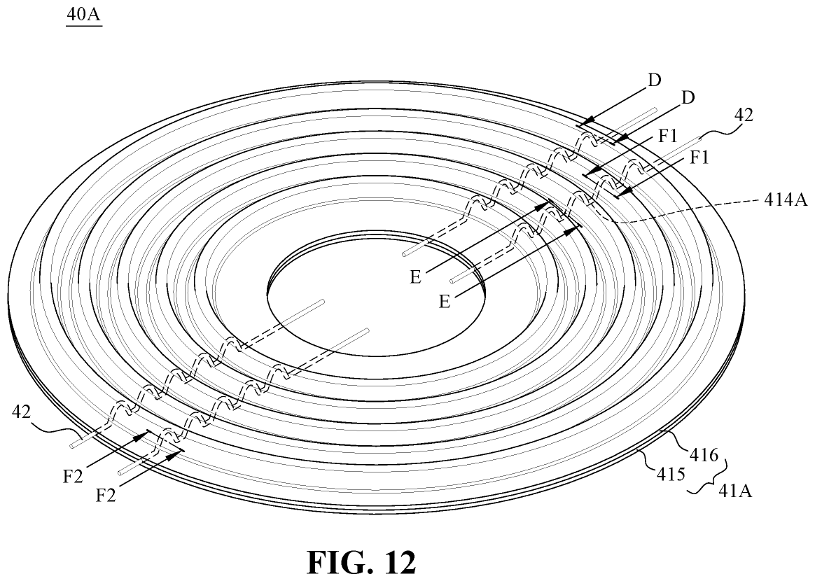

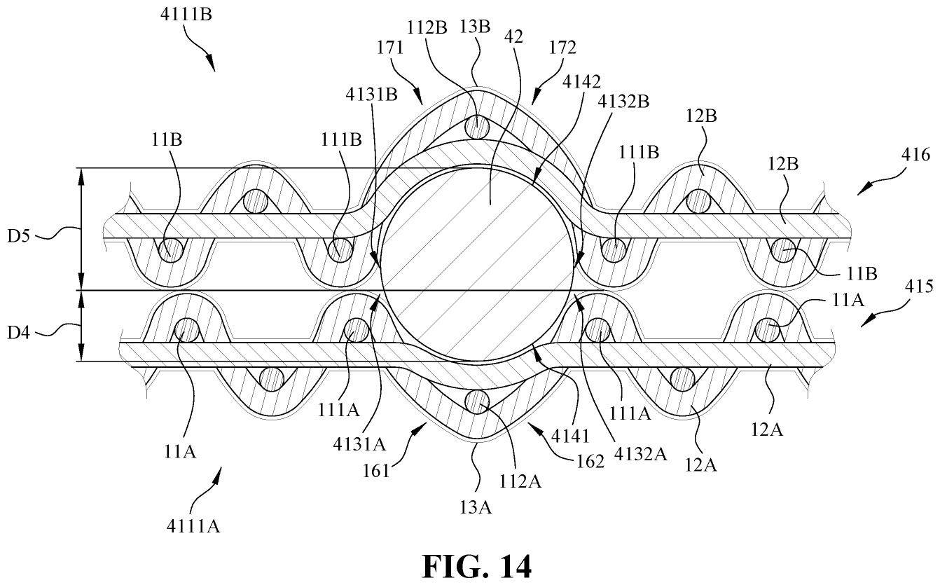

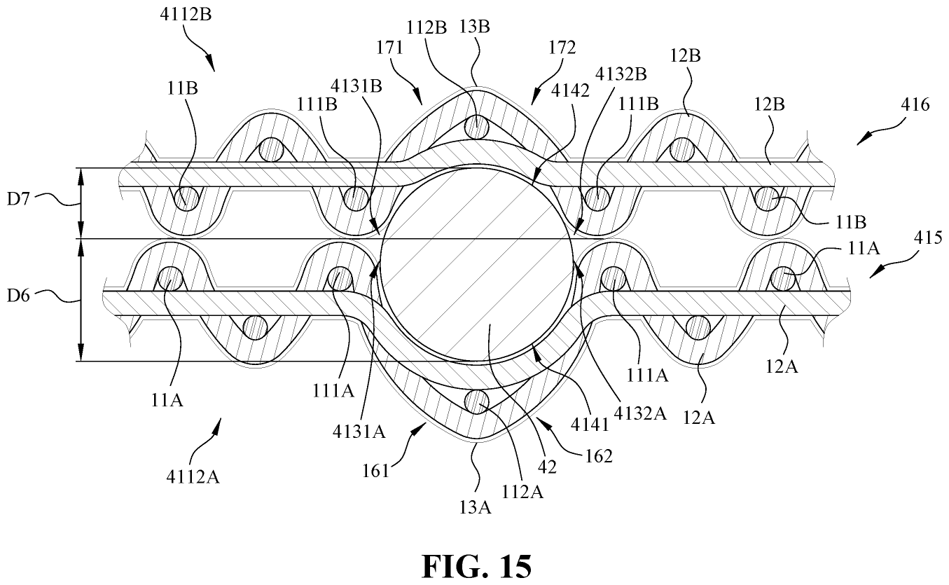

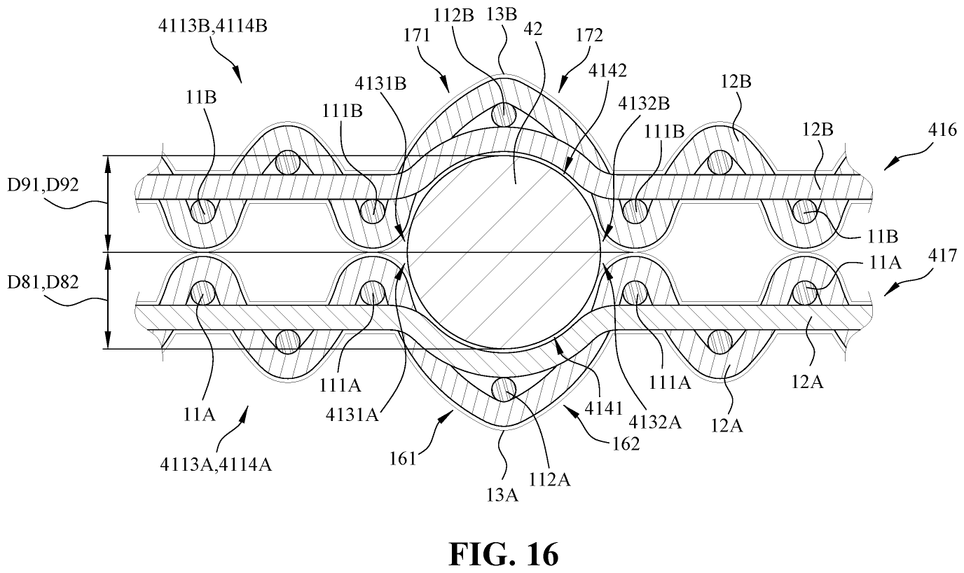

In a forming step S5, as shown in FIG. 11B, a wire damper 40A is formed on the base material 10A by thermoforming. As shown in FIGS. 12 to 16, the wire damper 40A includes a main body 41A and at least one wire 42. The main body 41A is a double-layer piece structure and includes a first piece 415 and a second piece 416. The first piece 415 is formed by interweaving the first warp yarns 11A and the first weft yarns 12A, and the first solid resin layer 13A is formed on the surface of the first piece 415. The first piece 415 includes a plurality of first wave structures 411A, a first center hole 412A, and at least one first wire disposing area 413A. The first wave structures 411A are sequentially arranged from the outer edge of the first piece 415 to the first center hole 412A. Each first wave structure 411A includes a first wave crest 4111A, a first wave trough 4112A, a first inner sidewall 4113A, and a first outer sidewall 4114A. The at least one first wire disposing area 413A extends radially from the outer edge of the first piece 415 through the first wave structures 411A to the first center hole 412A. The second piece 416 is formed by interweaving the second warp yarns 11B and the second weft yarns 12B, and the second solid resin layer 13B is formed on the surface of the second piece 416. The second piece 416 includes a plurality of second wave structures 411B, a second center hole 412B, and at least one second wire disposing area 413B. The second wave structures 411B are sequentially arranged from the outer edge of the second piece 416 to the second center hole 412B. Each second wave structure 411B includes a second wave crest 4111B, a second wave trough 4112B, a second inner sidewall 4113B, and a second outer sidewall 4114B. The at least one second wire disposing area 413B extends radially from the outer edge of the second piece 416 through the second wave structures 411B to the second center hole 412B. The first piece 415 is combined with the second piece 416, and the at least one first wire disposing area 413A corresponds to the at least one second wire disposing area 413B. The at least one first wire disposing area 413A is recessed inwardly to form at least one first trench 4141, and the at least one second wire disposing area 413B is recessed inwardly to form at least one second trench 4142. The at least one first trench 4141 and the at least one second trench 4142 together form at least one hollow portion 414A. The at least one wire 42 extends in the at least one hollow portion 414A, and both ends of the at least one wire 42 respectively penetrate the inner and outer edges of the first piece 415 and the second piece 416. As shown in FIGS. 14 to 16, a first lower elastic adjustment area 161 is formed between a first warp yarn 111A closest to outside of a first side 4131A of the at least one first wire disposing area 413A and a first warp yarn 112A at inside of the at least one first wire disposing area 413A. A second lower elastic adjustment area 162 is formed between a first warp yarn 111A closest to outside of a second side 4132A of the at least one first wire disposing area 413A and the first warp yarn 112A at inside of the at least one first wire disposing area 413A. The widths of the first lower elastic adjustment area 161 and the second lower elastic adjustment area 162 are equal to each other, and the distances between the remaining first warp yarns 11A are less than the width of each of the first lower elastic adjustment area 161 and the second lower elastic adjustment area 162. As shown in FIGS. 14 to 16, a first upper elastic adjustment area 171 is formed between a second warp yarn 111B closest to outside of a first side 4131B of the at least one second wire disposing area 413B and a second warp yarn 112B at inside of the at least one second wire disposing area 413B. A second upper elastic adjustment area 172 is formed between a second warp yarn 111B closest to outside of a second side 4132B of the at least one second wire disposing area 413B and the second warp yarn 112B at inside of the at least one second wire disposing area 413B. The widths of the first upper elastic adjustment area 171 and the second upper elastic adjustment area 172 are equal to each other, and the distances between the remaining second warp yarns 11B are less than the width of each of the first upper elastic adjustment area 171 and the second upper elastic adjustment area 172. As shown in FIGS. 14 to 16, the depth D4 of the at least one first trench 4141 at the first wave crests 4111A is less than the depth D5 of the at least one second trench 4142 at the second wave crests 4111B. The depth D6 of the at least one first trench 4141 at the first wave troughs 4112A is greater than the depth D7 of the at least one second trench 4142 at the second wave troughs 4112B. The depth D81 of the at least one first trench 4141 at the first inner sidewalls 4113A is equal to the depth D91 of the at least one second trench 4142 at the second inner sidewalls 4113B. The depth D82 of the at least one first trench 4141 at the first outer sidewalls 4114A is equal to the depth D92 of the at least one second trench 4142 at the second outer sidewalls 4114B. Preferably, as shown in FIGS. 14 and 15, the depth D4 of the at least one first trench 4141 at the first wave crests 4111A is equal to the depth D7 of the at least one second trench 4142 at the second wave troughs 4112B; and the depth D5 of the at least one second trench 4142 at the second wave crests 4111B is equal to the depth D6 of the at least one first trench 4141 at the first wave troughs 4112A. Also, as shown in FIG. 16, the depth D81 of the at least one first trench 4141 at the first inner sidewalls 4113A is equal to the depth D82 of the at least one first trench 4141 at the first outer sidewalls 4114A; and the depth D91 of the at least one second trench 4142 at the second inner sidewalls 4113B is equal to the depth D92 of the at least one second trench 4142 at the second outer sidewalls 4114B. In the second embodiment, the wire damper 40A includes four wires 42. The first piece 415 includes four first wire disposing areas 413A, and the second piece 416 includes four second wire disposing areas 413B. The wires 42 are respectively disposed at the first wire disposing areas 413A and the second wire disposing areas 413B. The first wire disposing areas 413A are recessed inwardly to form four first trenches 4141, the second wire disposing areas 413B are recessed inwardly to form four second trenches 4142, and the first trenches 4141 and the second trenches 4142 together form four hollow portions 414A. The wires 42 extend in the hollow portions 414A respectively.

In an assembling step S7, as shown in FIG. 11B, the first center hole 412A and the second center hole 412B are both sleeved at a voice coil.

As shown in FIGS. 12 to 16, the present invention provides a loudspeaker 70A having a wire damper with locally adjustable elasticity, wherein the differences between the structures of the loudspeaker 70A of the second embodiment and the loudspeaker 70 of the first embodiment are as described above.

According to this, since the wires 42 are not fixedly adhered onto the surface of the yarns of the first fabric 101 when being disposed on the first fabric 101, when the wire damper 40 is formed on the base material 10 by thermoforming of the thermoforming device 50, the first wire disposing areas 413A and the second wire disposing areas 413B can be pressurized by the wires 42, thereby recessing inwardly to form the first trenches 4141 and the second trenches 4142, and the first trenches 4141 and the second trenches 4142 can further forms the hollow portions 414A. It ensures that the wires 42 will not be damaged by the thermal pressurization of the thermoforming device 50. As a result, the manufactured wire damper 40 has a high yield and a low manufacturing cost.

Furthermore, by the first lower elastic adjustment areas 161 and the second lower elastic adjustment areas 162, the hardness, elasticity and toughness of the first wire disposing areas 413A can be adjusted; and by the first upper elastic adjustment areas 171 and the second upper elastic adjustment areas 172, the hardness, elasticity and toughness of the second wire disposing areas 413B can be adjusted. Therefore, the first wire disposing areas 413A and the second wire disposing areas 413B become softer, and their elasticity and toughness are increased. Thereby, the hardness, elasticity, and toughness of the combination of the first wire disposing areas 413A, the second wire disposing areas 413B and the wires 42 are equivalent to that of other areas of the main body 41A. Therefore, the wire damper 40A has uniform hardness, elasticity and toughness, thereby having uniform elastic resilience and fatigue resistance, and being not easy to be deformed and brittle, which improves the output sound quality of the loudspeaker.

In addition, the thermoforming device 50 must uniformly apply force to each wire 42 to ensure that each wire 42 will not be deformed due to being non-uniformly forced. However, the thermoforming device 50 requires larger pressurizing force to be able to form the first wave crests 4111A, the first wave troughs 4112A, the second wave crests 4111B and the second wave troughs 4112B by thermoforming. Also, the thermoforming device 50 requires less pressurizing force to be able to form the first inner sidewalls 4113A, the first outer sidewalls 4114A, the second inner sidewalls 4113B and the second outer sidewalls 4114B by thermoforming. Therefore, the depth D4 of the first trenches 4141 at the first wave crests 4111A is less than the depth D5 of the second trenches 4142 at the second wave crests 4111B. The depth D6 of the first trenches 4141 at the first wave troughs 4112A is greater than the depth D7 of the second trenches 4142 at the second wave troughs 4112B. The depth D81 of the first trenches 4141 at the first inner sidewalls 4113A is equal to the depth D91 of the second trenches 4142 at the second inner sidewalls 4113B. The depth D82 of the first trenches 4141 at the first outer sidewalls 4114A is equal to the depth D92 of the second trenches 4142 at the second outer sidewalls 4114B. In other words, the depths of the hollow portions 414A are non-uniform. Since the hollow portions 414A with non-uniform depth allow the wires 42 to extend therein in an non-uniform arrangement manner, the thermoforming device 50 can uniformly apply force to each wire 42, such that the wires 42 can maintain their original shape and will not be deformed, thereby improving the output sound quality of the loudspeaker. Under the condition that the wires 42 maintain their original shapes, the diameter of the hollow portions 414A in the space between the first wave crests 4111A and the second wave crests 4111B is equal to the diameter of the wires 42; the diameter of the hollow portions 414A in the space between the first wave troughs 4112A and the second wave troughs 4112B is equal to the diameter of the wires 42; the diameter of the hollow portions 414A in the space between the first inner sidewalls 4113A and the second inner sidewalls 4113B is equal to the diameter of the wires 42; and the diameter of the hollow portions 414A in the space between the first outer sidewalls 4114A and the second outer sidewalls 4114B is equal to the diameter of the wires 42.

In addition, the depth D4 of the first trenches 4141 at the first wave crests 4111A is equal to the depth D7 of the second trenches 4142 at the second wave troughs 4112B, and the depth D5 of the second trenches 4142 at the second wave crests 4111B is equal to the depth D6 of the first trenches 4141 at the first wave troughs 4112A, such that the diameter of the hollow portions 414A in the space between the first wave crests 4111A and the second wave crests 4111B is equal to the diameter of the hollow portions 414A in the space between the first wave troughs 4112A and the second wave troughs 4112B. Furthermore, the depth D81 of the first trenches 4141 at the first inner sidewalls 4113A is equal to the depth D82 of the first trenches 4141 at the first outer sidewalls 4114A, and the depth D91 of the second trenches 4142 at the second inner sidewalls 4113B is equal to the depth D92 of the second trenches 4142 at the second outer sidewalls 4114B, such that the diameter of the hollow portions 414A in the space between the first inner sidewalls 4113A and the second inner sidewalls 4113B is equal to the diameter of the hollow portions 414A in the space between the first outer sidewalls 4114A and the second outer sidewalls 4114B. Therefore, the wire damper 40A has a more balanced overall structure with uniform hardness, elasticity and toughness, thereby having uniform elastic resilience and fatigue resistance, and being not easy to be deformed and brittle, which improves the output sound quality of the loudspeaker.

It is noted that since the wires 42 are sandwiched by the first fabric 101 and the second fabric 102, they will not contact with the thermoforming device 50, which ensures that the wires 42 will not be damaged by the thermal pressurization of the thermoforming device 50. As a result, the manufactured wire damper 40A has a high yield and a low manufacturing cost.

The mentioned above are only preferred embodiments for explaining the present invention but intend to limit the present invention in any forms, so that any modifications or verification relating to the present invention made in the same spirit of the invention should still be included in the scope of the invention as intended to be claimed.

What is claimed is:

1. A method for manufacturing a loudspeaker having a wire damper with locally adjustable elasticity, comprising the following steps:
a preparation step preparing a base material, which is a single-layer fabric structure and is formed by interweaving a plurality of warp yarns and a plurality of weft yarns;
an impregnating step impregnating the base material in a resin solution;
a drying step drying the base material to form a solid resin layer on the base material;
a wire disposing step disposing at least one wire on the base material;
a forming step forming a wire damper on the base material by thermoforming, in which the wire damper includes a main body and the at least one wire, the main body is a single-layer piece structure formed by interweaving the warp yarns and the weft yarns, the solid resin layer is formed on a surface of the main body, the main body includes a plurality of wave structures, a center hole and at least one wire disposing area, and the wave structures are sequentially arranged from an outer edge of the main body to the center hole, each wave structure includes a wave crest, a wave trough, an inner sidewall and an outer sidewall, and the at least one wire disposing area extends radially from the outer edge of the main body through the wave structures to the center hole; wherein the at least one wire disposing area is recessed inwardly to form at least one hollow portion, the at least one wire extends in the at least one hollow portion, and both ends of the at least one wire respectively penetrate an inner edge and the outer edge of the main body; wherein a first elastic adjustment area is formed between the warp yarn closest to outside of a first side of the at least one wire disposing area and the warp yarn at inside of the at least one wire disposing area, a second elastic adjustment area is formed between the warp yarn closest to outside of a second side of the at least one wire disposing area and the warp yarn at the inside of the at least one wire disposing area, widths of the first elastic adjustment area and the second elastic adjustment area are equal to each other, and distances between the remaining warp yarns are less than the width of each of the first elastic adjustment area and the second elastic adjustment area; and wherein each of depths of the at least one hollow portion at the inner sidewalls and the outer sidewalls is less than a depth of the at least one hollow portion at the wave crests, and each of the depths of the at least one hollow portion at the inner sidewalls and the outer sidewalls is less than a depth of the at least one hollow portion at the wave troughs;
a cutting step cutting the wire damper from the base material; and
an assembling step, in which a voice coil is movably disposed in a loudspeaker body, the center hole of the wire damper is sleeved at the voice coil, and the at least one wire of the wire damper is connected to the voice coil, so as to assemble a loudspeaker.

2. The method according to claim 1, wherein in the forming step, the depth of the at least one hollow portion at the wave crests is equal to the depth of the at least one hollow portion at the wave troughs, and the depth of the at least one hollow portion at the inner sidewalls is equal to the depth of the at least one hollow portion at the outer sidewalls.

3. A method for manufacturing a loudspeaker having a wire damper with locally adjustable elasticity, comprising the following steps:
a preparation step preparing a base material, which is a double-layer fabric structure and includes a first fabric and a second fabric, the first fabric is formed by interweaving a plurality of first warp yarns and a plurality of first weft yarns, the second fabric is formed by interweaving a plurality of second warp yarns and a plurality of second weft yarns;
an impregnating step impregnating the first fabric and the second fabric in a resin solution, respectively;
a drying step drying the first fabric and the second fabric, so as to form a first solid resin layer on the first fabric, and to form a second solid resin layer on the second fabric;
a wire disposing step, in which at least one wire is first disposed on the first fabric, and the second fabric is then disposed on the first fabric, so as to form the base material;
a forming step forming a wire damper on the base material by thermoforming, in which the wire damper includes a main body and the at least one wire, the main body is a double-layer piece structure and includes a first piece and a second piece, the first piece is formed by interweaving the plurality of first warp yarns and the plurality of first weft yarns, the first solid resin layer is formed on a surface of the first piece, the first piece includes a plurality of first wave structures, a first center hole and at least one first wire disposing area, the first wave structures are sequentially arranged from an outer edge of the first piece to the first center hole, each first wave structure includes a first wave crest, a first wave trough, a first inner sidewall and a first outer sidewall, the at least one first wire disposing area extends radially from the outer edge of the first piece through the first wave structures to the first center hole, the second piece is formed by interweaving the plurality of second warp yarns and the plurality of second weft yarns, the second solid resin layer is formed on a surface of the second piece, the second piece includes a plurality of second wave structures, a second center hole and at least one second wire disposing area, the second wave structures are sequentially arranged from an outer edge of the second piece to the second center hole, each second wave structure includes a second wave crest, a second wave trough, a second inner sidewall and a second outer sidewall, the at least one second wire disposing area extends radially from the outer edge of the second piece through the second wave structures to the second center hole; wherein the first piece is combined with the second piece, and the at least one first wire disposing area corresponds to the at least one second wire disposing area; wherein the at least one first wire disposing area is recessed inwardly to form at least one first trench, the at least one second wire disposing area is recessed inwardly to form at least one second trench, the at least one first trench and the at least one second trench together form at least one hollow portion, the at least one wire extends in the at least one hollow portion, and both ends of the at least one wire respectively penetrate inner edges and the outer edges of the first piece and the second piece; wherein a first lower elastic adjustment area is formed between the first warp yarn closest to outside of a first side of the at least one first wire disposing area and the first warp yarn at inside of the at least one first wire disposing area, a second lower elastic adjustment area is formed between the first warp yarn closest to outside of a second side of the at least one first wire disposing area and the first warp yarn at the inside of the at least one first wire disposing area, widths of the first lower elastic adjustment area and the second lower elastic adjustment area are equal to each other, and distances between the remaining first warp yarns are less than the width of each of the first lower elastic adjustment area and the second lower elastic adjustment area; wherein a first upper elastic adjustment area is formed between the second warp yarn closest to outside of a first side of the at least one second wire disposing area and the second warp yarn at inside of the at least one second wire disposing area, a second upper elastic adjustment area is formed between the second warp yarn closest to outside of a second side of the at least one second wire disposing area and the second warp yarn at the inside of the at least one second wire disposing area, widths of the first upper elastic adjustment area and the second upper elastic adjustment area are equal to each other, and distances between the remaining second warp yarns are less than the width of each of the first upper elastic adjustment area and the second upper elastic adjustment area; and wherein a depth of the at least one first trench at the first wave crests is less than a depth of the at least one second trench at the second wave crests, a depth of the at least one first trench at the first wave troughs is greater than a depth of the at least one second trench at the second wave troughs, a depth of the at least one first trench at the first inner sidewalls is equal to a depth of the at least one second trench at the second inner sidewalls, a depth of the at least one first trench at the first outer sidewalls is equal to a depth of the at least one second trench at the second outer sidewalls;
a cutting step cutting the wire damper from the base material; and
an assembling step, in which a voice coil is movably disposed in a loudspeaker body, the first center hole and the second center hole of the wire damper are sleeved at the voice coil, and the at least one wire of the wire damper is connected to the voice coil, so as to assemble a loudspeaker.

4. The method according to claim 3, wherein in the forming step, the depth of the at least one first trench at the first wave crests is equal to the depth of the at least one second trench at the second wave troughs, the depth of the at least one second trench at the second wave crests is equal to the depth of the at least one first trench at the first wave troughs, the depth of the at least one first trench at the first inner sidewalls is equal to the depth of the at least one first trench at the first outer sidewalls, and the depth of the at least one second trench at the second inner sidewalls is equal to the depth of the at least one second trench at the second outer sidewalls.

5. A loudspeaker having a wire damper with locally adjustable elasticity, comprising:
a loudspeaker body;
a voice coil movably disposed in the loudspeaker body; and
a wire damper, including:
a main body, which is a single-layer piece structure formed by interweaving a plurality of warp yarns and a plurality of weft yarns, a solid resin layer is formed on a surface of the main body, the main body includes a plurality of wave structures, a center hole and at least one wire disposing area, and the wave structures are sequentially arranged from an outer edge of the main body to the center hole, each wave structure includes a wave crest, a wave trough, an inner sidewall and an outer sidewall, and the center hole is sleeved at the voice coil, the at least one wire disposing area extends radially from the outer edge of the main body through the wave structures to the center hole; wherein the at least one wire disposing area is recessed inwardly to form at least one hollow portion; wherein a first elastic adjustment area is formed between the warp yarn closest to outside of a first side of the at least one wire disposing area and the warp yarn at inside of the at least one wire disposing area, a second elastic adjustment area is formed between the warp yarn closest to outside of a second side of the at least one wire disposing area and the warp yarn at the inside of the at least one wire disposing area, widths of the first elastic adjustment area and the second elastic adjustment area are equal to each other, and distances between the remaining warp yarns are less than the width of each of the first elastic adjustment area and the second elastic adjustment area; and wherein each of depths of the at least one hollow portion at the inner sidewalls and the outer sidewalls is less than a depth of the at least one hollow portion at the wave crests, and each of the depths of the at least one hollow portion at the inner sidewalls and the outer sidewalls is less than a depth of the at least one hollow portion at the wave troughs; and
at least one wire, which extends in the at least one hollow portion, both ends of the at least one wire respectively penetrate an inner edge and the outer edge of the main body, and one end of the at least one wire is connected to the voice coil.

6. The loudspeaker according to claim 5, wherein the depth of the at least one hollow portion at the wave crests is equal to the depth of the at least one hollow portion at the wave troughs, and the depth of the at least one hollow portion at the inner sidewalls is equal to the depth of the at least one hollow portion at the outer sidewalls.

7. A loudspeaker having a wire damper with locally adjustable elasticity, comprising:
a loudspeaker body;
a voice coil movably disposed in the loudspeaker body; and
a wire damper, including:
a main body, which is a double-layer piece structure and includes a first piece and a second piece, the first piece is formed by interweaving a plurality of first warp yarns and a plurality of first weft yarns, a first solid resin layer is formed on a surface of the first piece, the first piece includes a plurality of first wave structures, a first center hole and at least one first wire disposing area, the first wave structures are sequentially arranged from an outer edge of the first piece to the first center hole, each first wave structure includes a first wave crest, a first wave trough, a first inner sidewall and a first outer sidewall, the at least one first wire disposing area extends radially from the outer edge of the first piece through the first wave structures to the first center hole, the second piece is formed by interweaving a plurality of second warp yarns and a plurality of second weft yarns, a second solid resin layer is formed on a surface of the second piece, the second piece includes a plurality of second wave structures, a second center hole and at least one second wire disposing area, the second wave structures are sequentially arranged from an outer edge of the second piece to the second center hole, each second wave structure includes a second wave crest, a second wave trough, a second inner sidewall and a second outer sidewall, the at least one second wire disposing area extends radially from the outer edge of the second piece through the second wave structures to the second center hole; wherein the first piece is combined with the second piece, and the at least one first wire disposing area corresponds to the at least one second wire disposing area, and the first center hole and the second center hole are sleeved at the voice coil; wherein the at least one first wire disposing area is recessed inwardly to form at least one first trench, the at least one second wire disposing area is recessed inwardly to form at least one second trench, the at least one first trench and the at least one second trench together form at least one hollow portion; wherein a first lower elastic adjustment area is formed between the first warp yarn closest to outside of a first side of the at least one first wire disposing area and the first warp yarn at inside of the at least one first wire disposing area, a second lower elastic adjustment area is formed between the first warp yarn closest to outside of a second side of the at least one first wire disposing area and the first warp yarn at the inside of the at least one first wire disposing area, widths of the first lower elastic adjustment area and the second lower elastic adjustment area are equal to each other, and distances between the remaining first warp yarns are less than the width of each of the first lower elastic adjustment area and the second lower elastic adjustment area; wherein a first upper elastic adjustment area is formed between the second warp yarn closest to outside of a first side of the at least one second wire disposing area and the second warp yarn at inside of the at least one second wire disposing area, a second upper elastic adjustment area is formed between the second warp yarn closest to outside of a second side of the at least one second wire disposing area and the second warp yarn at the inside of the at least one second wire disposing area, widths of the first upper elastic adjustment area and the second upper elastic adjustment area are equal to each other, and distances between the remaining second warp yarns are less than the width of each of the first upper elastic adjustment area and the second upper elastic adjustment area; and wherein a depth of the at least one first trench at the first wave crests is less than a depth of the at least one second trench at the second wave crests, a depth of the at least one first trench at the first wave troughs is greater than a depth of the at least one second trench at the second wave troughs, a depth of the at least one first trench at the first inner sidewalls is equal to a depth of the at least one second trench at the second inner sidewalls, a depth of the at least one first trench at the first outer sidewalls is equal to a depth of the at least one second trench at the second outer sidewalls; and
at least one wire, which extends in the at least one hollow portion, and both ends of the at least one wire respectively penetrate inner edges and the outer edges of the first piece and the second piece, and one end of the at least one wire is connected to the voice coil.

8. The loudspeaker according to claim 7, wherein the depth of the at least one first trench at the first wave crests is equal to the depth of the at least one second trench at the second wave troughs, the depth of the at least one second trench at the second wave crests is equal to the depth of the at least one first trench at the first wave troughs, the depth of the at least one first trench at the first inner sidewalls is equal to the depth of the at least one first trench at the first outer sidewalls, and the depth of the at least one second trench at the second inner sidewalls is equal to the depth of the at least one second trench at the second outer sidewalls.
